(19) United States
(12) Patent Application Publication
(10) Pub. No.: US 2002/0055436 A1
(43) Pub. Date: May 9, 2002

(54) Combinations of crop protection agents with organic or inorganic carrier materials

(76) Inventors: Hans-Peter Krause, Hofheim (DE); Gerhard Schnabel, Elsenfeld (DE); Gerhard Frisch, Wehrheim (DE); Jochen Wurtz, Bingen am Rhein (DE); Udo Bickers, Wietmarschen (DE); Erwin Hacker, Hochheim (DE); Thomas Auler, Bad Soden (DE); Alvaro Melendez, Schwalbach (DE); Detlev Haase, Frankfurt (DE)

Correspondence Address: FROMMER LAWRENCE & HAUG LLP, 745 Fifth Avenue, New York, NY, 10151, US

(21) Appl. No.: 09/853,313

(22) Filed: May 10, 2001

(30) Foreign Application Priority Data
May 11, 2000 (DE) 10022989.1

(51) Int. Cl. A01N 63/00; A01N 25/32; A01N 25/28; A01N 25/10; A01N 25/00

(52) U.S. Cl. 504/118; 504/359; 504/360; 504/361; 504/103; 514/949; 514/950; 514/962; 514/963; 514/772

(57) ABSTRACT

The present invention describes the use of a combination of an agrochemically active compound and a solid carrier material which surrounds the active compound, to suppress antagonistic interactions in a mixture comprising the active compound surrounded by the carrier material, and at least one further agrochemically active compound. Preferred formulations comprising such a combination include herbicides combined with a carrier material together with a safener and/or a growth regulator. Using the formulations according to the present invention, it is possible to suppress antagonistic interactions between different active compounds.

The present invention relates to combinations of crop protection agents with organic or inorganic carrier materials which permit a controlled release of an active compound. Using the combinations, it is possible to prevent antagonisms and to achieve particularly good results in the case of herbicides, in particular in the case of mixtures of herbicides with growth regulators and safeners.

It is known that various application problems, for example reduced activity owing to antagonistic interactions between two or more active compounds, can occur during the application of various agrochemical products, for example herbicides, fungicides, insecticides, plant growth regulators, safeners or fertilizers. It is furthermore known that these phenomena are frequently observed during so-called foliar application, and again in particular in the case of herbicides or else of mixtures of herbicides with safeners and/or growth regulators.

To avoid these problems, a so-called split application, for example, or an overdosage of the active compound that is antagonized has been recommended in cases of reduced activity due to antagonism. However, for various reasons, all of these procedures are rather unattractive and uneconomical. When using split application, the active compound formulation has to be applied at least twice; this is time-consuming and labor-intensive. Overdosage of an active compound results in additional expenditure.

U.S. Pat. No. 5,428,000 discloses active compound compositions comprising a herbicide for broad-leaved weeds and a herbicide for weed grasses. The herbicide for weed grasses has a neutral charge; in contrast, the herbicide for broad-leaved weeds is of anionic nature and is present in combination with a hydrophilic polymer, the polymer being a copolymer formed from an ammonium-containing compound and a compound which does not contain any ammonium. The ammonium-containing compound is generally derived from aromatic and non-aromatic nitrogen heterocycles, ammonium derivatives of acrylic acid and benzylammonium compounds. The hydrophilic polymers used are exclusively copolymers of the abovementioned type. The herbicides for weed grasses used are sethoxydim, alloxidim, fluazifop, quizalofop or fenoxaprop; for broad-leaved weeds, the use of bentazone, imazaquin, acifluorfen, fomesafen, chlorimuron, imazethapyr, thifensulfuron and 2,4-D has been described.

DE 198 33 066 discloses aqueous dispersions of polymers with cationic functionality and redispersible powders obtainable from the dispersions, and also their use, inter alia for the delayed release of active compounds of any kind.

It is an object of the present invention to provide formulations of crop protection agents which render split applications and overdosage obsolete.

This object is achieved by using a controlled release combination of an agrochemically active compound, in particular a herbicide, and a carrier which surrounds the active compound, to suppress antagonistic interactions in a mixture of the active compound which is surrounded by the carrier material, and at least one further agrochemically active compound.

It has been found that problems such as reduced activity owing to antagonistic interactions can be avoided by combining certain organic or inorganic carrier materials with one or more agrochemically active compounds.

The present invention furthermore provides the application of the combination according to the invention for controlling undesirable harmful organisms, in particular undesirable grasses and broad-leaved weeds.

In the novel carrier/active compound combination, the agrochemically active compound is incorporated into suitable carrier materials of organic or inorganic origin. These carrier materials surround the active compounds such that the latter cannot pass directly into the surrounding area. The active compounds are separated physically from the surrounding area and the further active compound(s). The active compound is only released by certain mechanisms, for example degradation of the carrier material, bursting of the carrier that surrounds the active compound or diffusion.

The agrochemically active compound which is incorporated fully or partially into the carrier can be an active compound which can have antagonistic action in an intended active compound mixture. It is also possible for two or more active compounds in an active compound mixture to be incorporated into a carrier.

The incorporation of active compounds into carrier materials for providing formulations which allow controlled release is known in principle and can be found in the expert literature. Examples can be found in C. L. Foy, D. W. Pritchard, “Pesticide Formulation and Technology”, CRC Press, 1996, page 273 ff. and literature cited therein, and in D. A. Knowles, “Chemistry and Technology of Agrochemical Formulations”, Kluwer Academic Press, 1998, page 132 ff. and literature cited therein.

The carrier materials which surround or coat the active compounds are chosen such that they are solid in a suitable temperature range, preferably in a range of about 0-50° C. Solid materials are to be understood as meaning materials which are hard, resilient in a wax-like manner, amorphous or crystalline, but which are not or not yet present in the liquid state. The carrier materials can be of inorganic or organic nature and of synthetic or natural origin.

One possibility of incorporating the agrochemically active compounds into suitable carrier materials is, for example, microencapsulation. These microcapsules can consist of polymeric materials of synthetic and/or natural origin. Examples of suitable materials include polyureas, polyurethanes, polyamides, melamine resins, gelatin, wax and starch.

Microcapsules of some of these materials can be prepared, for example, by the interfacial polycondensation method. Particle size and wall thickness, and thus also the release rates, can be controlled easily via the amount of monomers, the amount of active compound, the amounts of water and solvent and the process parameters.

In the case of microcapsules made of polyurethanes or polyureas, the method that is most frequently employed for constructing the capsule wall mentioned around the active compound to be coated is an interfacial polymerization with oil-in-water emulsions, where the organic phase contains an oil-soluble prepolymer with free isocyanate groups, in addition to the active compound.

Suitable prepolymers are the customary isocyanates known to the person skilled in the art, for example based on toluene 2,4-diisocyanate, toluene 2,6-diisocyanate, methylenelis (phenyl 4-isocyanate) and hexamethylene diisocyanate.

The polymerization, i.e. the synthesis of the mantel of the microcapsules, is generally carried out by customary methods known to the person skilled in the art.

The capsule-forming material from which the microcapsule mantels are constructed is preferably obtained from oil-soluble isocyanate group-containing prepolymers, which are a group of industrial mixed products, in each case consisting of polyisocyanates based on condensates of aniline and formaldehyde. These industrial mixed products differ from one another in the degree of condensation and, if appropriate, chemical modifications. For the user, important characteristics are viscosity and the content of free isocyanate groups. Typical commercial products are the Desmodur® brand (Bayer AG) and the Voranate® brand (Dow Chemicals). For the invention, the amount of prepolymer with isocyanate groups used is preferably ≦5% by weight, based on the total formulation; preference is given to 0.5-5% by weight, in particular 1-2% by weight.

The capsule-forming material is formed by curing the isocyanate prepolymer either in the presence of water at 0-95° C., preferably 20-65° C. or, preferably, using the required amount of a di- or polyamine.

If the microcapsules are formed using di- or polyamines, suitable di- or polyamines are, for example, alkylenediamines, dialkylenetriamines and trialkylenetetramines whose carbon chain units comprise between 2 and 8 carbon atoms. Preference is given to hexamethylenediamine. Here, it is possible to use amounts which are stoichiometric to the amount of isocyanate prepolymer used, or, preferably, to use an excess of up to three times, particularly up to two times, the stoichiometric amount.

The literature discloses further methods for preparing microcapsules from polyurethanes or polyurea, which methods are likewise suitable for preparing the microcapsules according to the invention. These methods are listed below.

U.S. Pat. No. 3,577,515 describes how, after introduction of water-soluble polyamines, the droplet surface in such emulsions cures as a result of addition to the prepolymers containing isocyanate groups. This forms a polyurea outer mantle.

U.S. Pat. No. 4,140,516 discloses that, even in the absence of external water-soluble amines, microcapsules having an outer wall of the polyurea type can be produced by permitting partial hydrolysis in the emulsion of the prepolymer bearing isocyanate functions. In the course of this, some of the amino groups are reformed from the isocyanate groups and, as a result of internal polyaddition with subsequent curing, the desired capsule mantle is likewise formed. The use of tolylene diisocyanate, hexamethylene diisocyanate, methylenebis(phenyl isocyanate) and of its higher homologues is described. If curing is to be performed using an external polyamine, this usually originates from the group consisting of ethylene diamine, propylenediamine, hexamethylenediamine, diethylenetriamine and tetraethylenepentamine.

DE-A-2 757 017 discloses internally structured microcapsules whose wall material has the nature of a mixed polymer crosslinked by urea and urethane motifs. The active compound is situated in the interior of the capsule, dissolved in an organic solvent. Typically, to make up the capsule wall here, 10% of prepolymer, based on the total formulation, is required.

The same prepolymer is also used in WO-A-96/09760 to encapsulate, for example, endosulfan.

WO-A-95/23506 discloses endosulfan-charged polyurea microcapsules in which the active compound is present as a cooled melt. As prepolymer, a mixture of methylenebis(phenyl isocyanate) and its higher homologues is described; the amount of prepolymer used is over 6%, based on the total formulation. Curing is performed using a mixture of polyamines.

The content of the patents and patent applications listed above is, with respect to the materials of the microcapsule wall and the preparation processes, an important and integral part of the present invention and is included in the present application by way of reference.

A further possibility of encapsulation is capsule formation using, for example, melamine/formaldehyde or urea/formaldehyde.

To this end, melamine, or the abovementioned isocyanate prepolymers, is/are initially charged in water and admixed with the water-insoluble active compound. Prior to the addition, the active compound has been dispersed or dissolved in a water-insoluble solvent and emulsified. By establishing an acidic pH of about 3-4, preferably about 3-5, and stirring at elevated temperature between 30 and 60° C., preferably 50° C., for several hours, the capsule wall is formed by polycondensation. Examples are described in U.S. Pat. Nos. 4,157,983 and 3,594,328, the content of which, with respect to the preparation of the capsules, is included in the present application by way of reference.

Another suitable method for microencapsulation of the agrochemically active compounds is coacervation. To this end, the water-insoluble agrochemically active compound is dispersed in water and admixed with an anionic water-soluble polymer and a cationic material. The microcapsules formed by so-called coacervation, containing the originally water-soluble polymer as wall material, are water-insoluble. In the last step, the capsule is then cured by condensation with aldehydes. Suitable for this purpose is, for example, the combination gelatin/gum arabic (1:1) and formaldehyde. The process of microencapsulation by coacervation is known to the person skilled in the art. The method is described in detail, for example, in J. A. Bahan “Microencapsulation using Coacervation/Phase Separation Techniques, Controlled Released Technology: Methods Theory and Application”, Vol. 2, Kydoniens, A. F, Ed. CRC Press, Inc., Boca Raton, Fla. 1980, Chapter 4.

For microencapsulation, it is finally possible, for example, to [lacuna] the active compound and the polymer which forms the capsule wall in water with a suitable surfactant [lacuna]. The solvent is then evaporated with stirring. When the water is removed, the polymer forms a layer on the surface of the emulsified drop.

Another suitable material for preparing microcapsules is wax. To this end, self-emulsifying waxes are dissolved in water by heating and applying shear forces, or are converted into an emulsion by adding surfactants and heating, whilst applying shear forces. Lipophilic agrochemically active compounds dissolve in molten and emulsified wax. During cooling, the drops solidify, thus forming the wax dispersion.

Alternatively, it is possible to prepare wax dispersions by dispersing active compound/wax extrusion granules in water or oil, followed by fine grinding, for example to particle sizes of <20 μm.

Suitable waxes are, for example, PEG 6000 in a mixture with non-hydrophilic waxes, Synchrowachs HGLC1, Mostermont® CAV2, Hoechst-Wachs OP3 or combinations of these waxes.

An aqueous dispersion of the particles (microcapsules or wax particles) can be obtained similarly to the recipes for a CS formulation (capsule suspension).

The microcapsules obtained by the methods described above can be incorporated into various formulations mentioned below in the text. It is also possible to incorporate further active compounds into the formulation, for example water-soluble active compounds into the aqueous phase of the capsule dispersion, or, for example, solid active compounds into WG formulations.

After microencapsulation, the capsules can be freed from the solvent and dried by customary methods, for example spray drying. In this state, the capsules can be stored and shipped. Prior to application to the crop in question, they are formulated, optionally with further active compounds, adjuvants and the customary additives.

However, the dispersion obtained after curing of the capsules can also be used for preparing suitable agrochemical formulations which comprise the abovementioned further components, without isolation of the capsules from the dispersions.

In these microcapsule dispersions, it is possible to use organic solvents or mixtures thereof, from the group of the N-alkyl fatty acid amides, N-alkyllactams, fatty acid esters, cyclohexanones, isophorones, phthalic esters and aromatic hydrocarbons, lower-alkyl-substituted naphthalene derivatives being particularly suitable.

Solvents which are suitable for the purpose of the invention and commercially available are, for example, Solvesso® 200, Solvesso® 150 and Solvesso® 100 (1), butyl diglycol acetate, Shellsol® RA (2), Acetrel® 400 (3), Agsolex® 8 (4), Agsolex® 12 (5), Norpar® 13 (6), Norpar® 15 (7), Isopar® V (8), Exsol® D 100 (9), Shellsol® K (10) and Shellsol® R (11), which are of the following composition:

(1) Mixtures of aromatic compounds; manufacturer: Exxon.

(2) Mixtures of alkylated benzenes, boiling range 183-312° C., manufacturer: Shell.

(3) High-boiling mixture of aromatic compounds, boiling range: 332-355° C., manufacturer: Exxon.

(4) N-Octylpyrrolidone, boiling point (0.3 mmHg) 100° C., manufacturer: GAF.

(5) N-Dodecylpyrrolidone, boiling point (0.3 mmHg) 145° C., manufacturer: GAF.

(6) Aliphatic hydrocarbons, boiling range: 228-243° C., manufacturer: Exxon.

(7) Aliphatic hydrocarbons, boiling range: 252-272° C., manufacturer: Exxon.

(8) Aliphatic hydrocarbons, boiling range: 278-305° C., manufacturer: Exxon.

(9) Aliphatic hydrocarbons, boiling range: 233-263° C., manufacturer: Exxon.

(10) Aliphatic hydrocarbons, boiling range: 192-254° C., manufacturer: Shell.

(11) Aliphatic hydrocarbons, boiling range: 203-267° C., manufacturer: Shell.

Also suitable are mixtures of these solvents with one another. Particularly suitable are butyl diglycol acetate, Acetrel® 400, Agsolex® 8 and Agsolex® 12. Particular preference is given to Solvesso® 200.

The aqueous phase of the dispersions according to the invention contains surface-active formulation auxiliaries from the group of the emulsifiers and dispersants. They originate from a group which comprises, for example, the compound families of the polyvinyl alcohols, the polyalkylene oxides, the condensates of formaldehyde with naphthalenesulfonic acids and/or phenols, the polyacrylates, the copolymers of maleic anhydride with alkylene alkyl ether, the lignosulfonates, and the polyvinylpyrrolidones. These substances are employed in an amount of from 0.2 to 10% by weight, preferably from 0.5 to 4% by weight, based in each case on the total dispersion.

In the case of polyalkylene oxides, preference is given to block copolymers whose molecular center and molecular periphery are formed by a polypropylene oxide block and polyethylene oxide blocks, respectively. Here, particular preference is given to substances in which the polypropylene oxide block has a molar mass of 2000-3000 and the percentage of the polyethylene oxide blocks is 60 to 80% of the total molar mass. Such a substance is available, for example, from BASF Wyandotte under the name Pluronic® F87.

Further suitable dispersants are calcium lignosulfonate, highly refined sodium lignosulfonate (for example Vanisperse® CB from Borregaard), dispersant S and dispersant SS from Clariant GmbH, naphthalene/sulfonic acid/formaldehyde condensate sodium salt (for example Morwet® D 425 from Witco or Tamol® NN 8906 from BASF), sodium polycarboxylate (for example Sopropan® T 36 from Rhodia GmbH).

Suitable polyvinyl alcohols are prepared by partial hydrolysis of polyvinyl acetate. They have a degree of hydrolysis of from 72 to 99 mol % and a viscosity of from 2 to 18 cP (measured in 4% strength aqueous solution at 200° C., in accordance with DIN 53 015). Preference is given to using partially hydrolyzed polyvinyl alcohols having a degree of hydrolysis of from 83 to 88 mol % and low viscosity, in particular from 3 to 5 cP.

If appropriate, the aqueous phase of the dispersions comprises at least one further formulation auxiliary from the group of the wetting agents, the antifreeze agents, the thickeners, the preservatives and viscosity-increasing components.

Suitable wetting agents are, for example, representatives from the substance groups of the alkylated naphthalenesulfonic acids, the N-fatty acyl N-alkyl taurides, the fatty acylamidoalkylbetaines, the alkyl polyglycosides, the alpha-olefinsulfonates, the alkylbenzenesulfonates, the esters of sulfosuccinic acid the (oligo)-alkylphenoltethoxylates, the fatty alcohol-(C₈-C₂₂)-ethoxylates, and the fatty alkyl sulfates (which may be modified by alkyleneoxy groups). Here, the percentage is between 0 and 5% by weight, preferably between 0 and 2% by weight, based on the total formulation.

Suitable commercial products are, for example, Darvan® No. 3, Vanisperse® CB, Hoe S1728 (Clariant GmbH), Luviskol® K 30, Reserve C, Forianit® P, Sokalan® CP 10, Maranil A, Genapol® PF 40, Genapol® LRO, Genapol® T, Genapol® X, Genapol® O, tributylphenol polyglycol ether, such as the Sapogenat T brands (Clariant GmbH), nonylphenol polyglycol ether, such as the Arkopal® N brands (Clariant GmbH) or tristyrylphenol polyglycol ether derivatives.

Preservatives which may be added to the aqueous dispersions are the following agents: formaldehyde or hexahydrotriazine derivatives, such as, for example, Mergal® KM 200 from Riedel de Haen or Cobate® C from Rhone Poulenc, isothiazolinone derivatives, such as, for example, Mergal® K9N from Riedel de Haen or Kathon® CG from Rohm and Haas, 1,2-benzisothiazolin-2-ones, such as, for example, Nipacide® BIT 20 from Nipa Laboratorien GmbH or Mergal® K10 from Riedel de Haen or 5-bromo-5-nitro-1,3-dioxane (Bronidox® LK from Henkel). The percentage of these preservatives is at most 2% by weight, based on the total formulation.

Suitable antifreeze agents are, for example, mono- or polyhydric alcohols, glycol ethers or urea, in particular calcium chloride, glycerol, isopropanol, propylene glycol monomethyl ether, di- or tripropylene glycol monomethyl ether or cyclohexanol. The percentage of these antifreeze agents is at most 20% by weight, based on the total dispersion.

Thickeners may be of inorganic or organic nature; they can also be combined. Suitable thickeners are, for example, those based on alumosilicate, xanthane, methylcellulose, polysaccharides, alkaline earth metal silicate, gelatin and polyvinyl alcohol, such as, for example, Bentone® EW, Vegum®, Rodopol® 23 or Kelzan® S. Their percentage is 0.3% by weight, preferably 0-0.5% by weight, based on the total dispersion.

The invention also relates to a process for preparing the microcapsule dispersions according to the invention, which comprises initially preparing a crude preemulsion of organic and aqueous phase (without diamine) and then subjecting this preemulsion to shear forces by passing it through a mixer, which preferably operates continuously, for example a static mixer, a toothed colloid mill or the like. Only in this step is the fineness required for later microcapsule formation of the emulsified oil droplets achieved. Finally, if appropriate after addition of a diamine, the entire substance volume is cured by polyreaction. Alternatively, the addition of water-soluble polyamine is dispensed with, and the finished emulsion is stirred for a certain period of time at a suitable temperature, for example for 6 h at 70° C.

For preparing a controlled release combination it is also possible, instead of microencapsulation, to introduce the active compound into an organic matrix, such as, for example, wax. It is also possible to use inorganic matrices, for example silicates, alumosilicates or aluminum oxides or minerals based on these abovementioned materials. Incorporation into such an organic or inorganic matrix results in physical binding of the agrochemically active compounds.

Possible release mechanisms are, for example, abiotic and/or biotic degradation (weathering), bursting of the matrix or the capsule walls, or diffusion or dissolution of the active compound from the matrix or the capsules. This may take place depending on the contact with liquids, for example water, or depending on the temperature.

In general, the major amount of active compound is released from the matrix or the microcapsules within the first 4 weeks after application, preferably within the first 7 days, in particular within the first 2 days.

Active compounds which cannot be released in a controlled manner can be used either as commercial products or can be formulated using technologies known in principle and can be combined in the tank with the corresponding controlled-release-formulations.

Suitable active compounds which can be embedded into the carrier materials used according to the invention are not limited to certain classes and include all known classes of agrochemically active compounds. Examples include herbicides, fungicides, insecticides, growth regulators, safeners, molluscicides, acaricides and nematicides.

Particularly suitable are herbicides, and among these in particular acetolactate synthase (ALS) inhibitors, such as, for example, sulfonylureas and salts thereof, hydroxybenzonitriles, such as, for example, bromoxynil and ioxynil, and derivatives thereof, such as esters or salts, bentazone, so-called aryloxyalkylcarboxylic acids and derivatives thereof, in particular esters, such as MCPA, 2,4-D, CMPP, 2,4-DP, 2,4-DB, so-called (hetero)aryloxyaryloxyalkylcarboxylic acids and derivatives thereof, in particular esters, such as, for example, fenoxaprop-ethyl, dichlofop-methyl, clodinafop-propargyl, fluazifop, HPPDO-inhibitors, such as, for example, mesotrione or sulfotrione, triazines, cyclohexanedione oximes, such as, for example, sethoxidim, clethodim or trialkoxidim; growth regulators or hormone-like substances, such as, for example, indolylacetic acid or indolylbutyric acid or chemical derivatives thereof, such as, for example, esters, or auxins; safeners, such as, for example, mefenpyr-diethyl or analogous esters and 5,5-biphenyl-2-isoxazoline-3-carboxylic acid or analogous esters.

In the case of all the abovementioned agrochemically active compounds it is, of course, also possible, if appropriate, to use the corresponding derivatives known to the person skilled in the art as being suitable for use, such as acids, esters or salts of the active compounds.

The combinations according to the invention permit antagonization of other active compounds in mixtures with the former to be suppressed. Active compounds to be combined according to the invention can therefore be used in a mixture with other active compounds, if appropriate together with customary additives and adjuvants. Examples of preferred combinations according to the invention are described below. In all these combinations, the use of the active compounds described above as being particularly suitable or most suitable is, of course, likewise preferred, even if this is not explicitly mentioned.

The agrochemically active compounds combined with the carriers used according to the invention can be formulated with other active compounds which, if appropriate, are likewise combined according to the present invention with suitable carriers, to afford mixtures giving advantageous results.

A preferred embodiment of the present invention are combinations in which some or all of an agrochemically active compound, for example a herbicide, is combined according to the invention with a carrier such as a polymer, the combinations additionally comprising at least one further agrochemically active compound, for example a herbicide or safener.

In a further preferred embodiment of the present invention, herbicides with safeners and/or growth regulators are formulated in combination with the carrier used according to the invention, where at least one of the agrochemically active compounds has been partially or fully combined according to the invention with a carrier.

A further preferred embodiment of the combination according to the invention comprises mixtures of one or more graminicides with one or more herbicides which act against broad-leaved weeds, where at least one of the agrochemically active compounds has been partially or fully combined according to the invention.

In a further preferred embodiment of the combination according to the invention, one or more graminicides are mixed with a safener, where at least one of the agrochemically active compounds has been partially or fully combined according to the invention.

According to the present invention, it is furthermore preferred to combine one or more herbicides having a rapid mechanism of action with one or more herbicides having a relatively slow mechanism of action, where at least one of the agrochemically active compounds has been partially or fully combined according to the invention.

In many cases, it is advantageous to add adjuvants or adjuvant mixtures, for example of oils, solvents, surfactants or surfactant mixtures. Here, adjuvants are to be understood as meaning those additives to active compound/polymer combinations which are not active themselves but enhance the properties of the active compound. Suitable adjuvants are nonionic surfactants, for example those of the formula RO(CH₂CH₂O)ₙH, in which R is a (C₁₀-C₂₂)-fatty alcohol radical, a tristyrylphenol radical, a tributylphenol radical, a (C₁-C₁₄)-alkylphenol radical, a tridecyl alcohol radical, a glyceride radical or a radical derived from castor oil and n is an integer of from 1-500, preferably from 3-200.

Such substances are obtainable, for example, as Genapol-®, Sapogenat-® and Arkopol® series from Clariant GmbH and as Soprophor series from Rhodia GmbH. It is also possible to employ block copolymers based on ethylene oxide, propylene oxide and/or butylene oxide, for example the compounds sold by BASF AG under the names Pluronics® or Tetronics®.

Anionic or betainic surfactants, too, can be used. Examples of anionic surfactants include calcium dodecylbenzylsulfonate, succinates, phosphated, sulfatated and sulfonated nonionic surfactants, for example those of the type mentioned above, and sorbitane-derivatives such as sorbitates, these anionic compounds being neutralized with alkali metal, alkaline earth metal or ammonium ions. Such surfactants are available, for example, under the name Genapol® LRO (Clariant GmbH).

Also suitable are cationic surfactants, for example those based on quaternary ammonium, phosphonium and tertiary sulfonium salts, for example Atlas® G3634 A from Uniquema.

The amount of surfactant used is from 10 to 2000 g/ha, preferably from 50 to 2000 g/ha. The addition of nitrogen, for example in the form of urea, ammonium nitrate, ammonium sulfate, ammonium hydrogen sulfate or mixtures thereof, is likewise often advantageous.

In the table below, formulations comprising combinations according to the invention are described in an exemplary manner. Here, preferred carriers are polyureas. In the application, it may be advantageous to apply further active compounds with the formulations mentioned in the table.

| Active compound 1 | | |
|---|---|---|
| (fully or partially | Active compound 2 | |
| combined with carrier) | (not combined) | Other additives |
| Safener such as | Fatty acid synthesis | Addition of adjuvants, |
| mefenpyr-diethyl ester | inhibitors such as | e.g. Genapol ® LRO, |
| (10-50 g/ha) | (hetero)aryloxyphenoxy- | is advantageous |
| | alkylcarboxylic acids and | |
| | cyclohexanedione | |
| | oximes, e.g. fenoxyprop- | |
| | P-ethyl | |
| | (20-100 g/ha) | |
| Safener such as 5,5- | Fatty acid synthesis | Addition of adjuvants, |
| biphenyl-2-isoxaline- | inhibitors such as | e.g. Genapol LRO is |
| 3-carboxylic acid or | (hetero)aryloxyphenoxy- | advantageous |
| salts or esters thereof | alkylcarboxylic acids and | |
| | cyclohexanedione | |
| | oximes, e.g. fenoxaprop- | |
| | p-ethyl | |
| Protoporphyrinogen | Glufosinate or bialaphos | Addition of adjuvants, |
| oxidase inhibitors, | | e.g. Genapol ® LRO, |
| such as, for example, | | and/or nitrogen |
| fluthiacet-methyl | | fertilizer (e.g. |
| | | ammonium sulfate, |
| | | ammonium hydrogen |
| | | sulfate, urea) is |
| | | advantageous |
| Protoporphyrinogen | Glyphosate | Addition of adjuvants, |
| oxidase inhibitors, | | e.g. Genapol ® LRO, |
| such as, for example, | | and/or nitrogen |
| fluthiacet-methyl | | fertilizer (e.g. |
| | | ammonium sulfate, |
| | | ammonium hydrogen |
| | | sulfate, urea) is |
| | | advantageous |
| p-Hydroxyphenyl- | Glufosinate or Bialafos | Addition of adjuvants, |
| pyruvate dioxygenase | | e.g. Genapol ® LRO, |
| inhibitors, such as | | and/or nitrogen |
| isoxaflutole, | | fertilizer (e.g. |
| sulcotrione or | | ammonium sulfate, |
| mesotrione | | ammonium hydrogen |
| | | sulfate, urea) is |
| | | advantageous |
| p-Hydroxyphenyl- | Glyphosate | Addition of adjuvants, |
| pyruvate dioxygenase | | e.g. Genapol ® LRO, |
| inhibitors, such as | | and/or nitrogen |
| isoxaflutol, sulcotrione | | fertilizer (e.g. |
| or mesotrione | | ammonium sulfate, |
| | | ammonium hydrogen |
| | | sulfate, urea) is |
| | | advantageous |
| Bromoxynil or | Fatty acid synthesis | Addition of adjuvants, |
| chemical derivatives | inhibitors, such as | e.g. Genapol ® LRO |
| (esters, salts) in | (hetero)aryloxyphenoxy- | is advantageous |
| combination with | alkylcarboxylic acids and | |
| safeners, e.g. | cyclohexanedione | |
| mefenpyrdiethyl | oximes, | |
| Aryloxyalkyl- | Fatty acid synthesis | Addition of adjuvants, |
| carboxylic acids or | inhibitors such as | e.g. Genapol ® LRO |
| chemical derivatives | (hetero)aryloxyphenoxy- | is advantageous |
| (esters, salts), e.g. | alkylcarboxylic acids and | |
| 2,4-D | cyclohexanedione | |
| | oximes, e.g. fenoxaprop- | |
| | p-ethyl | |
| Aryloxyalkyl- | Fatty acid synthesis | Addition of adjuvants, |
| carboxylic acids or | inhibitors such as | e.g. Genapol ® LRO |
| chemical derivatives | (hetero)aryloxyphenoxy- | is advantageous |
| (esters, salts), e.g. | alkylcarboxylic acids and | |
| 2,4-D in combination | cyclohexanedione | |
| with safeners, e.g. | oximes, e.g. fenoxaprop- | |
| mefenpyr-diethyl | p-ethyl | |
| Bromoxynil or | Fatty acid synthesis | Addition of adjuvants, |
| chemical derivatives | inhibitors such as | e.g. Genapol ® LRO |
| (esters, salts) | (hetero)aryloxyphenoxy- | is advantageous |
| | alkylcarboxylic acids and | |
| | cyclohexanedione | |
| | oximes, e.g. fenoxaprop- | |
| | P-ethyl, in combination | |
| | with a sulfonylurea, e.g. | |
| | metsulfuron or | |
| | iodosulfuron | |
| Bromoxynil or | Fatty acid synthesis | Addition of adjuvants, |
| chemical derivatives | inhibitors such as | e.g. Genapol ® LRO |
| (esters, salts) in | (hetero)aryloxyphenoxy- | is advantageous |
| combination | alkylcarboxylic acids and | |
| with safeners, e.g. | cyclohexanedione | |
| mefenpyrdiethyl | oximes, e.g. fenoxyprop- | |
| | P-ethyl, in combination | |
| | with a sulfonylurea, e.g. | |
| | metsulfuron or | |
| | iodosulfuron | |
| Safener, e.g. | p-Hydroxyphenyl- | |
| mefenpyr-diethyl | pyruvate | |
| or 5,5-biphenyl- | dioxygenase inhibitors, | |
| 2-isoxaline-3- | such as isoxaflutol, | |
| carboxylic | sulcotrione or mesotrione | |
| acid or salts or | | |
| esters thereof | | |
| Safener, e.g. | Sulfonylureas, e.g. | Addition of adjuvants, |
| mefenpyrdiethyl or | foramsulfuron, | e.g. Genapol ® LRO |
| 5,5-biphenyl-2- | rimsulfuron | and/or nitrogen |
| isoxaline-3-carboxylic | | fertilizer (e.g. |
| acid or salts or esters | | ammonium sulfate, |
| thereof | | ammonium hydrogen |
| | | sulfate, urea) is |
| | | advantageous |
| Fatty acid synthesis | Safener, e.g. ethyl 5,5- | Addition of adjuvants, |
| inhibitors, e.g. | biphenyl-2-isoxazoline-3- | e.g. Genapol ® LRO |
| fenoxaprop-P-ethyl | carboxylate | and/or nitrogen |
| | | fertilizer (e.g. |
| | | ammonium sulfate, |
| | | ammonium hydrogen |
| | | sulfate, urea) is |
| | | advantageous |
| Bromoxynil ester | Sulfonylureas, such as | Addition of adjuvants, |
| (octanoate, heptanoate, | foramsulfuron, also in | e.g. Genapol ® LRO |
| butyrate or mixtures) | combination with | and/or nitrogen |
| | safeners, e.g. ethyl 5,5- | fertilizer (e.g. |
| | biphenyl-2-isoxazoline-3- | ammonium sulfate, |
| | carboxylate | ammonium hydrogen |
| | | sulfate, urea) is |
| | | advantageous |
| Triazine herbicides | Sulfonylureas, such as | Addition of adjuvants, |
| (cellulose biosynthesis | iodosulfuron and/or | e.g. Genapol ® LRO |
| inhibitors) | mesosulfuron, also in | and/or nitrogen |
| | combination with | fertilizer (e.g. |
| | safeners, e.g. mefenpyr- | ammonium sulfate, |
| | diethyl or analogous | ammonium hydrogen |
| | esters | sulfate, urea) is |
| | | advantageous |

The percentage of the active compounds in the various formulations can be varied within wide ranges. The formulations comprise, for example, from about 0.1 to 95% by weight of active compounds, about 90-10% by weight of liquid or solid carriers and, if appropriate, up to 30% by weight, of surfactants, where the sum of these percentages should be 100%.

The mixtures, prepared according to the invention, with carrier material, one or more active compounds and optional adjuvants and other auxiliaries can also be present as a separate tank mix, and also in other formulations.

Suitable possible formulations are, for example:

wettable powders (WP), water-soluble powders (SP), suspension concentrates (SC) based on oil or water, water-soluble concentrates (SL), emulsifiable concentrates (EC), micro- and macroemulsions (EW/ME), such as oil-in-water and water-in-oil emulsions, sprayable solutions, suspension emulsions (SE), oil-miscible solutions, capsule suspensions (CS), dusts (DP), seed-dressing compositions, granules for broadcasting and soil application, granules (GR) in the form of micro granules, spray granules, coating granules and adsorption granules, water-dispersible granules (WDG), water-soluble granules (WSG), ULV formulations, microcapsules and waxes.

These individual formulation types are known in principle and are described, for example, in Winnacker-Küchler, “Chemische Technologie” [Chemical Technology], Volume 7, C. Hanser Verlag Munich, 4th Edition, 1986; Wade van Valkenburg, “Pesticide Formulations”, Marcel Dekker, N.Y., 1973; K. Martens, “Spray Drying” Handbook, 3^{rd} Ed. 1979, G. Goodwin Ltd. London.

Formulation auxiliaries, such as inert materials, surfactants, solvents and other additives, are likewise known and are described, for example, in Watkins, “Handbook of Insecticide Dust Diluents and Carriers”, 2^{nd} Ed., Darland Books, Caldwell N.J., H. v. Olphen, “Introduction to Clay Colloid Chemistry”, 2^{nd} Ed., J. Wiley & Sons, N.Y.; C. Marsden, “Solvents Guide”, 2^{nd} Ed., Interscience, N.Y. 1963; McCutcheon's “Detergents and Emulsifiers Annual”, MC Publ. Corp., Ridgewood N.J.; Sisley and Wood, “Encyclopedia of Surface Active Agents”, Chem. Publ. Co. Inc., N.Y. 1964; Schönfeldt, “Grenzflächenaktive Äthylenoxidaddukte [Surface-Active Ethylene Oxide Adducts]”, Wiss. Verlagsgesell., Stuttgart 1976; Winnacker-Küchler, “Chemische Technologie”, Volume 7, C. Hanser Verlag Munich, 4th Edition, 1986.

Wettable powders are preparations which are uniformly dispersible in water and which contain, in addition to the combination according to the invention and as well as a diluent or inert substance, surfactants of ionic and/or anionic nature (wetting agents, dispersants), for example polyethoxylated alkyl phenols, polyethoxylated fatty alcohols, polyethoxylated fatty amines, fatty alcohol polyglycol ether sulfates, alkanesulfonates, alkylbenzenesulfonates, sodium lignosulfonate, sodium 2,2′-dinaphthylmethane-6,6′-disulfonate, sodium dibutylnaphthalenesulfonate or else sodium oleylmethyltaurinate. To prepare the wettable powders, the active compounds are finely ground in customary apparatus such as hammer mills, fan mills or air-jet mills, and are mixed simultaneously or subsequently with the formulation auxiliaries and the polymers used according to the invention.

Emulsifiable concentrates are prepared by dissolving the active compound in combination with the polymer in an organic solvent, for example butanol, cyclohexanone, dimethylformamide, xylene or else relatively high-boiling aromatic compounds or hydrocarbons or mixtures of the organic solvents, with the addition of one or more surfactants of ionic and/or nonionic nature (emulsifiers). Examples of emulsifiers which can be used are calcium alkylarylsulfonates, such as calcium dodecylbenzenesulfonate, or nonionic emulsifiers, such as alkylaryl polyglycol ethers different from para-alkylphenol ethoxylates, fatty acid polyglycol esters, fatty alcohol polyglycol ethers, propylene oxide-ethylene oxide condensation products, alkyl 25 polyethers, sorbitan esters, for example sorbitan fatty acid esters, or polyoxyethylene sorbitan esters, for example polyoxyethylene sorbitan fatty acid esters. Dusts are obtained by grinding the active compound in combination with polymers to be used according to the invention with finely divided solid substances, for example, talc, natural clays, such as kaolin, bentonite and pyrophyllite, or diatomaceous earth.

Suspension concentrates can be water- or oil-based. They can be prepared, for example, by wet milling using commercially customary bead mills, with or without the addition of surfactants as already mentioned above under the other formulation types.

Emulsions, for example oil-in-water emulsions (EW), can be prepared, for example, by means of stirrers, colloid mills and/or static mixers using aqueous organic solvents and, if desired, surfactants, for example as already mentioned above under the other formulation types.

Granules can be prepared either by spraying the active compound in combination with the polymer to be used according to the invention onto adsorptive, granulated inert material or by applying the combination to the surface of carriers, such as sand, kaolinites or of granulated inert material, by means of adhesives, for example sugars, such as pentoses and hexoses or even mineral oils. Suitable active compounds in combination with the polymer to be used according to the invention can also be granulated in the manner which is customary for the preparation of fertilizer granules, if desired as mixtures with fertilizers.

Water-dispersible granules are generally prepared by the customary processes, such as spray-drying, fluidized-bed granulation, disk granulation, mixing using high-speed mixers, and extrusion without solid inert material.

For the preparation of disk, fluidized-bed, extruder and spray granules, see, for example, the processes in “Spray-Drying Handbook” 3^{rd} Ed. 1979, G. Goodwin Ltd., London; J. E. Browning, “Agglomeration”, Chemical and Engineering 1967, pages 147 ff.; “Perry's Chemical Engineer's Handbook”, 5^{th} Ed., McGraw-Hill, New York 1973, pp. 8-57.

For further details on the formulation of crop protection products, see, for example, G. C. Klingman, “Weed Control as a Science”, John Wiley and Sons, Inc., New York, 1961, pages 81-96 and J. D. Freyer, S. A. Evans, “Weed Control Handbook”, 5^{th} Ed., Blackwell Scientific Publications, Oxford, 1968, pages 101-103.

In addition, said formulations with the combinations according to the invention may comprise the tackifiers, wetting agents, dispersants, emulsifiers, penetrants, preservatives, antifreeze agents, solvents, fillers, carriers, colorants, antifoams, evaporation inhibitors and pH and viscosity regulators which are customary in each case.

Based on these formulations, it is also possible to prepare mixtures with other pesticidally active compounds, such as herbicides, insecticides, fungicides, and also antidotes or safeners, fertilizers and/or growth regulators, for example in the form of a finished formulation or for use as tank mixes.

The combinations according to the invention have outstanding activity. If herbicides are combined with polymers to give the combinations according to the invention, the combinations have excellent herbicidal activity against a broad spectrum of economically important monocotyledonous and dicotyledonous harmful plants. The active compound combinations also act efficiently on perennial weeds which produce shoots from seeds or rhizomes, root stocks or other perennial organs and which are difficult to control. In this context, it is immaterial whether the combinations according to the invention are applied pre-sowing, pre-emergence or post-emergence. The combinations according to the invention are preferably applied onto above-ground parts of plants. The combinations according to the invention are also suitable for dessicating crop plants such as potato, cotton and sunflower. In the case of herbicidally active compounds, the combinations according to the invention can be used, for example, for controlling the following harmful plants:

Dicotyledonous weeds of the genera Sinapis, Galium, Stellaria, Matricaria, Galinsoga, Chenopodium, Brassica, Urtica, Senecio, Amaranthus, Portulaca, Xanthium, Convolvulus, lpomoea, Polygonum, Sesbania, Cirsium, Carduus, Sonchus, Solanum, Lamium, Veronica, Abutilon, Datura, Viola, Monochoria, Commalina, Sphenoclea, Aeschynomene, Heteranthera, Papaver, Euphorbia and Bidens.

Monocotyledonous weeds of the genera Avena, Alopecurus, Echinochloa, Setaria, Panicum, Digitaria, Poa, Eleusine, Brachiaria, Lolium, Bromus, Cyperus, Elytrigia, Sorphum, Apera and Scirpus.

If the herbicidal compositions which comprise the combinations according to the invention are applied prior to germination, then the weed seedlings are either prevented completely from emerging, or the weeds grow until they have reached the cotyledon stage but then their growth stops, and, eventually, after three to four weeks have elapsed, they die completely.

If these herbicidal compositions which comprise the combinations according to the invention are applied post-emergence to the green parts of the plants, growth also stops drastically a very short time after the treatment and the weed plants remain at the development stage of the point in time of application, or they die completely after a certain time, more or less rapidly, so that in this manner competition by the weeds, which is harmful to the crop plants, can be eliminated at a very early point in time and in a sustained manner by employing the novel combinations according to the invention, as are associated quantitative and qualitative losses in yield.

Although these combinations according to the invention have excellent herbicidal activity against monocotyledonous and dicotyledonous weeds, damage to the crop plant is insignificant, if there is any damage at all.

These effects permit, inter alia, the application rate to be reduced, a broader spectrum of broad-leaved weeds and weed grasses to be controlled, activity gaps to be closed, also with respect to resistant species, more rapid and safer action, longer duration of action, complete control of the harmful plants using only one or a few applications, and a prolonged application period if a plurality of active compounds are present at the same time.

The abovementioned properties are required for weed control in practice to keep agricultural crops free of undesirable competing plants and to safeguard and/or increase yield quality and quantity. With respect to the properties described, the combinations according to the invention are considerably superior to the prior art.

In addition, the combinations according to the invention permit, in an excellent manner, the control of otherwise resistant harmful plants.

Owing to their agrochemical properties, preferably herbicidal, plant-growth-regulatory and safener properties, the combinations according to the invention, which are preferably employed in herbicidal compositions, can also be employed for controlling harmful plants in crops of known or still to be developed genetically engineered plants. The transgenic plants generally have particularly advantageous properties, for example resistance to certain pesticides, in particular certain herbicides, resistance to plant diseases or causative organisms of plant diseases, such as certain insects or microorganisms such as fungi, bacteria or viruses. Other particular properties relate, for example, to the quantity, quality, storage-stability, composition and to specific ingredients of the harvested product. Thus, transgenic plants having an increased starch content or a modified quality of the starch or those having a different fatty acid composition of the harvested product are known.

The use of the combinations according to the invention in economically important transgenic crops of useful and ornamental plants, for example of cereal, such as wheat, barley, rye, oats, millet, rice, manioc and corn, or else in crops of sugar beet, cotton, soya, oilseed rape, potato, tomato, pea and other vegetable species is preferred.

The combinations according to the invention with herbicides, plant growth regulators and/or safeners can preferably be used in crops of useful plants which are resistant or which have been made resistant by genetic engineering toward the phytotoxic effects of the herbicides.

Conventional ways for preparing novel plants which have modified properties compared to known plants comprise, for example, traditional breeding methods and the generation of mutants. Alternatively, novel plants having modified properties can be generated with the aid of genetic engineering methods (see, for example, EP-A-0 221 044, EP-A-0 131 624). For example, there have been described several cases of

genetically engineered changes in crop plants in order to modify the starch synthesized in the plants (for example WO 92/11376, WO 92/14827, WO 91/19806),

transgenic crop plants which are resistant to certain herbicides of the glufosinate (cf., for example, EP-A-0 242 236, EP-A-0 242 246) or glyphosate (WO 92/00377) or sulfonylurea (EP-A-0 257 993, U.S. Pat. No. 5,013,659) type, transgenic crop plants, for example cotton, having the ability to produce Bacillius thuringiensis toxins (Bt toxins) which impart resistance to certain pests to the plants (EP-A-0 142 924, EP-A-0 193 259),

transgenic crop plants having a modified fatty acid composition (WO 91/13972).

Numerous molecular biological techniques which allow the preparation of novel transgenic plants having modified properties are known in principle; see, for example, Sambrook et al., Molecular Cloning, A Laboratory Manual, 2nd Ed. Cold Spring Harbor Laboratory Press, Cold Spring Harbor, N.Y., or Winnacker “Gene and Klone”, VCH Weinheim, 2nd Edition, 1996 or Christou, “Trends in Plant Science” 1 (1996), 423-431.

In order to carry out such genetic engineering manipulations, it is possible to introduce nucleic acid molecules into plasmids which allow a mutagenesis or a change in the sequence to occur by recombination of DNA sequences. Using the abovementioned standard procedures, it is possible, for example, to exchange bases, to remove partial sequences or to add natural or synthetic sequences. To link the DNA fragments to one another, it is possible to attach adapters or linkers to the fragments.

Plant cells having a reduced activity of a gene product can be prepared, for example, by expressing at least one appropriate antisense-RNA, a sense-RNA to achieve a cosuppression effect, or by expressing at least one appropriately constructed ribozyme which specifically cleaves transcripts of the abovementioned gene product.

To this end, it is possible to employ either DNA molecules which comprise the entire coding sequence of a gene product including any flanking sequences that may be present, or DNA molecules which comprise only parts of the coding sequence, it being necessary for these parts to be long enough to cause an antisense effect in the cells. It is also possible to use DNA sequences which have a high degree of homology to the coding sequences of a gene product but which are not entirely identical.

When expressing nucleic acid molecules in plants, the synthesized protein can be localized in any desired compartment of the plant cell. However, to achieve localization in a certain compartment, it is, for example, possible to link the coding region with DNA sequences which ensure localization in a certain compartment. Such sequences are known to the person skilled in the art (see, for example, Braun et al., EMBO J. 11 (1992), 3219-3227; Wolter et al., Proc. Natl. Aca. Sci. USA 85 (1988), 846-850; Sonnewald et al., Plant J. 1 (1991), 95-106).

The transgenic plant cells can be regenerated to whole plants using known techniques. The transgenic plants can in principle be plants of any desired plant species, i.e. both monocotyledonous and dicotyledonous plants.

In this manner, it is possible to obtain transgenic plants which have modified properties by overexpression, suppresion or inhibition of homologous (=natural) genes or gene sequences or by expression of heterologous (=foreign) genes or gene sequences.

The combinations according to the invention can preferably be used in transgenic crops which are resistant to herbicides from the group consisting of the sulfonylureas, glufosinate-ammonium or glyphosate-isopropylammonium and analogous active compounds.

When using the combinations according to the invention, in particular those in herbicidal compositions, in transgenic crops, in addition to the effects against harmful plants which can be observed in other crops, there are frequently effects which are specific for the application in the respective transgenic crop, for example a modified or specifically broadened spectrum of weeds which can be controlled; modified application rates which can be used for the application; preferably good miscibility or combinability with those herbicides to which the transgenic crop is resistant; and an effect on the growth and the yield of the transgenic crop plants.

The invention is now additionally illustrated in the examples below.

Examples 1-17 describe combinations of active compounds with suitable carriers.

### EXAMPLE 1

10.7 g of fenoxaprop-p-ethyl (93.6% D+) were dissolved in 40.0 g of Solvesso® 200, and 3.0% of Voranate® M220 (Dow Chemicals, technical-grade methylenebis(phenyl isocyanate)) was stirred in until complete homogeneity had been reached. Furthermore, an aqueous solution was prepared, comprising 2.0 g of Mowiol® 3-83 (Clariant, polyvinyl alcohol) 1.8 g of Genapol® V4829 (Clariant, ethylene oxide/propylene oxide copolymer), 0.5% of Morwet® D425 (Witco, naphthalenesulfonic acid/formaldehyde condensate), 0.1 g of Rodorsil® 432 (Rhodia, defoamer based on silicone), 0.1 g of Mergal® K9N (preservative) and 36.3 g of water. The aqueous phase was initially charged in a 250 ml three-necked flask fitted with dropping funnel and stirrer motor/paddle stirrer, and the organic phase was added as quickly as possible, with vigorous stirring.

After about 0.5 h, the speed of the stirrer was reduced and an aqueous solution of 1.5 g of hexamethylenediamine in 2 g of water was metered in quickly from a syringe. Shortly afterwards, 4.0 g of technical-grade glycerol were added.

At the same rate, stirring was continued at room temperature for 4 h, and the finished microcapsule dispersion was removed.

This gave a microcapsule dispersion comprising 10% of fenoxaprop-P-ethyl. The vicosity was 600 mPas·s (100 sec), the mean capsule diameter was 3 μm.

### EXAMPLES 2-14

The following microcapsule dispersions can be obtained in a manner similar to example 1.

| | | | Capsule | |
|---|---|---|---|---|
| | | Loading (% | size | Quantity of |
| Ex- | Active compound | active | (Mean: | isocyanate |
| ample | (Microcapsule) | compound) | 10⁶m) | (%) |
| 2 | fenoxaprop-P-ethyl | 10 | 2.6 | 1 |
| 3 | fenoxaprop-P-ethyl | 10 | 2.1 | 3 |
| 4 | fenoxaprop-P-ethyl | 10 | 1.6 | 5 |
| 5 | Bromoxynil octanoate | 10 | 2.0 | 1 |
| 6 | Bromoxynil octanoate | 10 | 2.1 | 5 |
| 7 | 2,4-D isobutyl ester | 10 | 1 | 5 |
| 8 | 2,4-D isobutyl ester | 10 | 5 | 5 |
| 9 | MCPA isooctyl ester | 10 | 5 | 1 |
| 10 | MCPA Isooctyl ester | 10 | 2.5 | 1 |
| 11 | mefenpyr-diethyl | 10 | 3.25 | 1 |
| 12 | mefenpyr-diethyl | 10 | 16.6 | 1 |
| 13 | 5,5-biphenyl-2-isoxaline- | 10 | 3.1 | 1 |
| | 3-carboxylic acid | | | |
| 14 | 5,5-biphenyl-2-isoxaline- | 10 | 2.9 | 5 |
| | 3-carboxylic acid | | | |

### EXAMPLE 15

Preparation of an EC Formulation of Fenoxaprop-P-ethyl

8.2% of fenoxaprop-P-ethyl, 53% of Solvesso®, 16% of N-methylpyrrolidone, 8.4% of Genapol®, X-060, 6.5% of Emulsagen 1816, 3.2% of phenyl sulfonate Ca 70 and 4.3% of Edenol® D-81 are mixed with one another.

### EXAMPLE 16

Preparation of an EC Formulation of 5,5-biphenyl-2-isoxazoline-3-carboxylic acid

8% of 5,5-biphenyl-2-isoxaline-3-carboxylic acid, 53.5% of Solvesso®, 16.1% N-methylpyrrolidone, 8.4% of Genapol®, X-060, 6.5% of Emulsagen 1816, 3.2% of phenyl sulfonate Ca 70 and 4.3% of Edenol® D-81 are combined and mixed.

### EXAMPLE 17

Preparation of an EC Formulation of Mefenpyr-diethyl

8% of mefenpyr-diethyl, 53.5% of Solvesso®, 16.1% of N-methylpyrrolidone, 8.4% of Genapol® X-060, 6.5% of Emulsogen 1816, 3.2% of phenyl sulfonate Ca 70 and 4.3% of Edenol® D-81 are combined and mixed with one another.

Examples 18-21 describe the application of active compound formulations comprising combinations according to the invention.

In these examples 18-21, seeds or rhizome pieces of mono- and dicotyledonous harmful and useful plants were placed in sandy loam soil in pots having a diameter of 9-13 cm and covered with soil. The pots were kept in a greenhouse under optimum conditions. In the two-to three-leaf stage, i.e. about 3 weeks after the start of the cultivation, the test plants were treated with the active compound combinations according to the invention in the form of aqueous dispersions or suspensions or emulsions and sprayed onto the green parts of the plants at an application rate of 300 l of water/ha (converted), in various dosages. For further cultivation of the plants, the pots were kept in the greenhouse under optimum conditions. Visual scoring of the damage to the useful and harmful plants was carried out 2-3 weeks after the treatment.

### EXAMPLE 18

The formulation of example 2 (60 g/ha) and the formulation of example 17 (15 g/ha) are applied together onto crops of wheat, for controlling grass. Compared to the same formulation without the carrier combination according to the invention, a better control of weed grasses is observed.

### EXAMPLE 19

The formulation of example 2 (30 g/ha) is mixed with the formulation of example 15 (30 g/ha) and the formulation of example 17 (15 g/ha) and applied to crops of wheat, for controlling grass. Better control of weed grasses is observed than in the case of a formulation which comprises the same active compounds, but not the combination according to the invention.

### EXAMPLE 20

A mixture comprising the formulation of example 2 (60 g/ha) and the formulation of example 16 (60 g/ha) is applied to crops of rice, for controlling weed grasses and broad-leaved weeds. Compared to a formulation which comprises the same combination of active compounds, but not the combination according to the invention, better control of weed grasses/broad-leaved weeds is observed.

### EXAMPLE 21

A mixture of a formulation according to example 15 (60 g/ha), the formulation of example 11 (15 g/ha) and the formulation of example 5 (300 g/ha) is applied to crops of wheat, for controlling weed grasses and broad-leaved weeds. Compared to a formulation which comprises the same amounts of the same active compounds, but not the combination according to the invention, better control of broad-leaved weeds and weed grasses is observed.

### EXAMPLE 22

A mixture of a formulation according to example 15 (60 g/ha fenoxaprop-p-ethyl), the formulation of example 16 (60 g/ha of isoxadiphen-ethyl) and the formulation of example 1 (40 g/ha of fenoxaprop-P-ethyl) is applied to crops of rice, for controlling grasses. Compared to a formulation which comprises the same amounts of the same active compounds, but not the combination according to the invention, better control of broad-leaved weeds and weed grasses is observed.

1. The use of a combination of an agrochemically active compound and a carrier surrounding the active compound, to suppress antagonistic interactions in a mixture comprising the active compound surrounded by the carrier material, and at least one further agrochemically active compound.

2. The use as claimed in claim 1, wherein the active compound is selected from the group consisting of herbicides, fungicides, insecticides, growth regulators, safeners, molluscicides, acaricides and nematicides, in particular herbicides, safeners, growth regulators, insecticides and fungicides.

3. The use as claimed in claim 2, wherein the herbicides are selected from the group consisting of ALS inhibitors, such as, for example, sulfonylureas, hydroxybenzonitriles, preferably bromoxynil and ioxynil, bentazone, aryloxyalkylcarboxylic acids, preferably MCPA, 2,4-D, CMPP, 2,4-DP, 2,4-DB, (hetero)aryloxyaryloxyalkylcarboxylic acids, preferably fenoxaprop-p-ethyl, dichlofop, clodinafop-propargyl, fluazifop, HPPDO-inhibitors, preferably mesotrione or sulfotrione, triazines, cyclohexanedione oximes, preferably sethoxidim, clethodim or trialkoxidim, the growth selectors are selected from the group consisting of indolyl acetic acid and indolyl butyric acid and auxins, the safeners are selected from the group consisting of mefenpyr-diethyl and 5,5-biphenyl-2-isoxazoline-3-carboxylic acid.

4. The use according to claim 1, wherein the carrier material is selected from the group consisting of materials of synthetic and natural origin and organic and inorganic nature, preferably polymers of natural and synthetic origin, wax, silicates, alumosilicates, alumina and minerals based on these materials.

5. The use as claimed in claim 4, wherein the active compound is surrounded by microcapsules as carrier, preferably by microcapsules constructed of polyureas, polyurethanes, polyamides, melamine resins, gelatin, wax and/or starch.

6. The use as claimed in claim 5, wherein the polyurethanes and the polyureas are prepared from isocyanate prepolymers, preferably from toluene 2,4-diisocyanate, toluene 2,6-diisocyanate, methylenebis(phenyl isocyanate) or hexamethylene diisocyanate.

7. The use as claimed in claim 5 or 6, wherein the microcapsules are prepared by interfacial polycondensation or coacervation.

8. A formulation, comprising a combination as claimed in claim 1 and at least one further component from the group consisting of agrochemically active compounds, surfactants, fertilizers and customary adjuvants.

9. The formulation as claimed in claim 8, comprising a combination of a herbicide and a carrier material together with a safener and/or a growth regulator.

10. A method for controlling harmful organisms, in particular harmful plants, which comprises applying a combination as claimed in claim 1 or a formulation as claimed in claim 8 or 9 in a manner known per se.

11. A process for preparing a combination as claimed in claim 1 or a formulation as claimed in claim 8 or 9, which comprises combining the active compound by customary processes known per se, preferably by dissolving, stirring or mixing, with a suitable carrier.
